(19) United States
(12) Patent Application Publication
(10) Pub. No.: US 2024/0359471 A1
(43) Pub. Date: Oct. 31, 2024

(54) INKJET RECORDING APPARATUS

(71) Applicant: KYOCERA Document Solutions Inc., Osaka (JP)

(72) Inventor: Yasutaka INUI, Osaka-shi (JP)

(73) Assignee: KYOCERA Document Solutions Inc., Osaka (JP)

(21) Appl. No.: 18/646,960

(22) Filed: Apr. 26, 2024

(30) Foreign Application Priority Data
Apr. 27, 2023 (JP) 2023-072841

(51) Int. Cl. B41J 2/165

(52) U.S. Cl. CPC B41J 2/16552; B41J 2/16502

(57) ABSTRACT

An inkjet recording apparatus includes an inkjet head, a supply path, a blade, and a cleaning liquid supply member. The inkjet head is provided with a nozzle surface on which ink ejection ports of a plurality of nozzles are opened downward. Through the supply path, a cleaning liquid is supplied. The blade is movable in contact with the nozzle surface. The cleaning liquid supply member supplies the cleaning liquid supplied through the supply path to at least one of the nozzle surface and the blade. The cleaning liquid supply member has at least one supply hole through which the cleaning liquid is supplied, and the supply path has a supply part inserted into the supply hole.

### INCORPORATION BY REFERENCE

This application is based on and claims the benefit of priority from Japanese patent application No. 2023-072841 filed on Apr. 27, 2023, which is incorporated by reference in its entirety.

### BACKGROUND

The present disclosure relates to an inkjet recording apparatus provided with a wipe unit which wipes ink adhered on a nozzle surface of an inkjet head.

An inkjet recording apparatus is provided with a wipe unit which wipes ink adhered on a nozzle surface of an inkjet head. The wipe unit includes a blade which moves in one direction from a moving start position to a moving end position while in contact with the nozzle surface, and is movable between a wiping position below the inkjet head and a separated position separated from the space below the inkjet head. When wiping, the wipe unit is moved to the wiping position, and the blade is moved from the moving start position to the moving end position while in contact with the nozzle surface, so that the ink adhered on the nozzle surface is wiped off by the blade.

In addition, the inkjet recording apparatus may be provided with a cleaning liquid supply member which supplies a cleaning liquid on the downstream side of the moving start position in the moving direction of the blade. The cleaning liquid supply member is provided adjacent to the nozzle surface of the inkjet head, for example. When wiping, the cleaning liquid is supplied from the cleaning liquid supply member, and the ink adhered on the nozzle surface is wiped off by the blade together with the cleaning liquid.

In the above-described inkjet recording apparatus, the cleaning liquid supply member is provided adjacent to the nozzle surface of the inkjet head. That is, since the cleaning liquid supply member is integrally provided on the inkjet head, the cleaning liquid supplied to the cleaning liquid supply member is adjacent to the nozzle surface even during printing. Therefore, if a sheet passing under the inkjet head may be bent upward during the printing, the sheet comes into contact with the cleaning liquid supply member, and the sheet may be contaminated by the cleaning liquid or the cleaning liquid supply member may be damaged by the sheet.

Further, when the cleaning liquid is supplied from a cleaning liquid tank to the cleaning liquid supply member, there is a problem that the cleaning liquid leaks or that an appropriate amount of the cleaning liquid cannot be supplied.

### SUMMARY

An inkjet recording apparatus according to the present disclosure includes an inkjet head, a supply path, a blade, and a cleaning liquid supply member. The inkjet head is provided with a nozzle surface on which ink ejection ports of a plurality of nozzles are opened downward. Through the supply path, a cleaning liquid is supplied. The blade is movable in contact with the nozzle surface. The cleaning liquid supply member supplies the cleaning liquid supplied through the supply path to at least one of the nozzle surface and the blade. The cleaning liquid supply member has at least one supply hole through which the cleaning liquid is supplied, and the supply path has a supply part inserted into the supply hole.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inner structure of an inkjet recording apparatus according to one embodiment of the present disclosure.

FIG. 2A is a plan view schematically showing head units and maintenance devices of the inkjet recording apparatus according to the embodiment of the present disclosure.

FIG. 2B is a front view schematically showing the head units and the maintenance devices of the inkjet recording apparatus according to the embodiment of the present disclosure.

FIG. 3A is a side view showing an inkjet head of the inkjet recording apparatus according to the embodiment of the present disclosure.

FIG. 3B is a bottom view showing the inkjet head of the inkjet recording apparatus according to the embodiment of the present disclosure.

FIG. 4 is a perspective view showing a cap unit of the inkjet recording apparatus according to the embodiment of the present disclosure.

FIG. 5 is a perspective view showing a wipe unit and a cleaning liquid supply mechanism of the inkjet recording apparatus according to the embodiment of the present disclosure.

FIG. 6A is a perspective view showing a carriage and a cleaning liquid supply member of the wipe unit of the inkjet recording apparatus according to the embodiment of the present disclosure.

FIG. 6B is a side view showing the carriage and the cleaning liquid supply member of the wipe unit of the inkjet recording apparatus according to the embodiment of the present disclosure.

FIG. 7 is a sectional view showing the cleaning liquid supply member of the wipe unit of the inkjet recording apparatus according to the embodiment of the present disclosure.

FIG. 8A is a perspective view showing the carriages moved to a moving start position, in the wipe unit of the inkjet recording apparatus according to the embodiment of the present disclosure.

FIG. 8B is a perspective view showing the carriages moved to a moving end position, in the wipe unit of the inkjet recording apparatus according to the embodiment of the present disclosure.

FIG. 9A is a side view showing the cleaning liquid supply mechanism moved to an insertion position, in the wipe unit of the inkjet recording apparatus according to the embodiment of the present disclosure.

FIG. 9B is a side view showing the cleaning liquid supply mechanism moved to a separated position, in the wipe unit of the inkjet recording apparatus according to the embodiment of the present disclosure.

FIG. 10 is a block diagram showing a control part of the inkjet recording apparatus according to the embodiment of the present disclosure.

FIG. 11A is a view schematically showing the head unit, the wipe unit, a blade, and the cleaning liquid supply mechanism during a wiping operation (at a home position), in the inkjet recording apparatus according to the embodiment of the present disclosure.

FIG. 11B is a view schematically showing the head unit, the wipe unit, the blade, and the cleaning liquid supply mechanism during the wiping operation (when the cleaning liquid supply mechanism is lifted), in the inkjet recording apparatus according to the embodiment of the present disclosure.

FIG. 12A is a view schematically showing the head unit, the wipe unit, the blade, and the cleaning liquid supply mechanism during the wiping operation (when the head unit is lifted), in the inkjet recording apparatus according to the embodiment of the present disclosure.

FIG. 12B is a view schematically showing the head unit, the wipe unit, the blade, and the cleaning liquid supply mechanism during the wiping operation (when the wipe unit is moved), in the inkjet recording apparatus according to the embodiment of the present disclosure.

FIG. 13A is a view schematically showing the head unit, the wipe unit, the blade, and the cleaning liquid supply mechanism during the wiping operation (when the head unit is lowered), in the inkjet recording apparatus according to the embodiment of the present disclosure.

FIG. 13B is a view schematically showing the head unit, the wipe unit, the blade, and the cleaning liquid supply mechanism during the wiping operation (when the carriages are moved), in the inkjet recording apparatus according to the embodiment of the present disclosure.

FIG. 14A is a view schematically showing the head unit, the wipe unit, the blade, and the cleaning liquid supply mechanism during the wiping operation (when the head unit is lifted), in the inkjet recording apparatus according to the embodiment of the present disclosure.

FIG. 14B is a view schematically showing the head unit, the wipe unit, the blade, and the cleaning liquid supply mechanism during the wiping operation (when the carriages are moved), in the inkjet recording apparatus according to the embodiment of the present disclosure.

FIG. 15A is a view schematically showing the head unit, the wipe unit, the blade, and the cleaning liquid supply mechanism during the wiping operation (when the wipe unit is moved), in the inkjet recording apparatus according to the embodiment of the present disclosure.

FIG. 15B is a view schematically showing the head unit, the wipe unit, the blade, and the cleaning liquid supply mechanism during the wiping operation (when the cleaning liquid supply mechanism is lowered), in the inkjet recording apparatus according to the embodiment of the present disclosure.

FIG. 16 is a view schematically showing the head unit, the wipe unit, the blade, and the cleaning liquid supply mechanism during the wiping operation (when the head unit is lowered), in the inkjet recording apparatus according to the embodiment of the present disclosure.

FIG. 17A is a view explaining a cleaning liquid supply process by a supply part of the cleaning liquid supply mechanism, in the wipe unit of the inkjet recording apparatus according to the embodiment of the present disclosure.

FIG. 17B is a view explaining the cleaning liquid supply process by the supply part of the cleaning liquid supply mechanism, in the wipe unit of the inkjet recording apparatus according to the embodiment of the present disclosure.

FIG. 17C is a view explaining the cleaning liquid supply process by the supply part of the cleaning liquid supply mechanism, in the wipe unit of the inkjet recording apparatus according to the embodiment of the present disclosure.

FIG. 18 is a view showing a modified example of the supply part of the cleaning liquid supply mechanism, in the wipe unit of the inkjet recording apparatus according to the embodiment of the present disclosure.

FIG. 19 is a view showing a modified example of the supply part of the cleaning liquid supply mechanism, in the wipe unit of the inkjet recording apparatus according to the embodiment of the present disclosure.

### DETAILED DESCRIPTION

Hereinafter, with reference to the attached drawings, an inkjet recording apparatus 1 according to one embodiment of the present disclosure will be described.

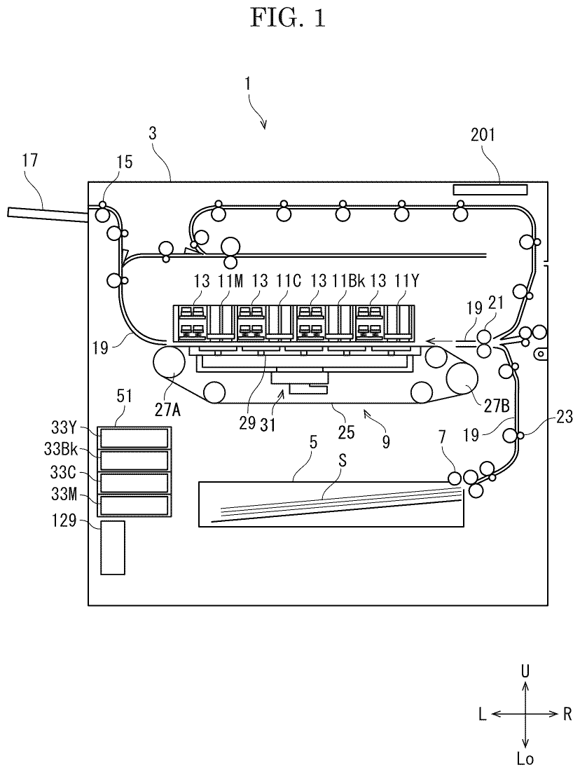

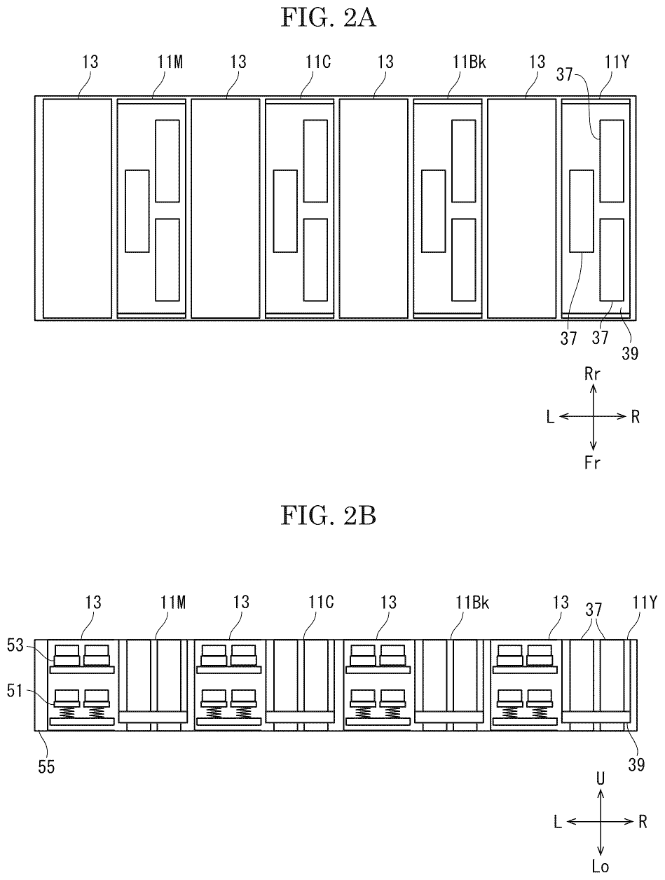

First, the entire structure of the inkjet recording apparatus 1 will be described with reference to FIG. 1, FIG. 2A, and FIG. 2B. FIG. 1 is a front view schematically showing the inside of the inkjet recording apparatus 1. FIG. 2A is a plan view schematically showing head units 11 and maintenance devices 13, and FIG. 2B is a side view schematically showing the head units 11 and the maintenance devices 13. Hereinafter, the front side of the paper plane on which FIG. 1 is drawn is defined as the front side of the inkjet recording apparatus 1. In each figure, U, Lo, L, R, Fr, and Rr indicate the upper, lower, left, right, front, and rear, respectively.

The inkjet recording apparatus 1 (see FIG. 1) is an inkjet image forming apparatus that forms an image by ejecting ink. The inkjet recording apparatus 1 includes a rectangular body housing 3. In the lower portion of the inside of the body housing 3, a sheet feeding cassette 5 in which a sheet S such as a plain paper and a coated paper is stored, and a sheet feeding roller 7 which feeds the sheet S from the sheet feeding cassette 5 are provided. Above the sheet feeding cassette 5, a conveying unit 9 which conveys the sheet S is provided. Above the conveying unit 9, four head units 11M, 11C, 11Bk, and 11Y (collectively referred to as the head unit 11) and four maintenance devices 13 (see also FIG. 2A and FIG. 2B) are provided. In the left and upper portion of the body housing 3, a discharge rollers pair 15 which discharges the sheet S having a formed image and a discharge tray 17 on which the discharged sheet S is stacked are provided.

Inside the body housing 3, a conveyance path 19 is formed from the sheet feeding cassette 5 through the conveying unit 9 to the discharge rollers pair 15. On the conveyance path 19, a plurality of conveying rollers pairs 21 which convey the sheet S is provided. On the conveyance path 19, a registration rollers pair 23 is provided on the upstream side of the conveying unit 9 in the conveying direction.

The conveying unit 9 will be described with reference to FIG. 1. The conveying unit 9 is provided with an endless conveying belt 25. The conveying belt 25 has a number of through-holes (not shown) penetrating in the thickness direction. The conveying belt 25 is wound around a driving roller 27A and a driven roller 27B disposed via an interval in the left-and-right direction. The driving roller 27A is driven by a motor (not shown) to be rotated. As the driving roller 27A is rotated, the conveying belt 25 travels in the counterclockwise direction of FIG. 1. The conveying belt 25 traveling along an upper track forms the conveyance path 19 along which the sheet S is conveyed in the conveying direction from the right to the left in FIG. 1.

In the hollow space of the conveying belt 25, a conveyance plate 29 and a suction device 31 are provided. The conveyance plate 29 has a number of through-holes penetrating in the thickness direction. The conveyance plate 29 is in contact with the inner surface of the conveying belt 25 traveling along the upper track. The suction device 31 is provided below the conveyance plate 29, and attracts the sheet S to the conveying belt 25 by sucking air through the through-holes of the conveying belt 25 and the through-holes of the conveyance plate 29.

Next, the head unit 11 will be described. The four head units 11Y, 11Bk, 11C, and 11M correspond to yellow, black, cyan, and magenta inks, respectively, and are disposed the conveying above belt at 25 predetermined intervals along the conveying direction. Ink containers 33Y, 33Bk, 33C, and 33M (collectively referred to as the ink container 33, see FIG. 1) filled with the yellow, black, cyan, and magenta inks, respectively, are connected to the four head units 11. As shown in FIG. 2A and FIG. 2B, each head unit 11 includes three inkjet heads 37 and a plate 39 for supporting the three inkjet heads 37. The ink is supplied to the three inkjet heads 37 from the respective ink containers 33.

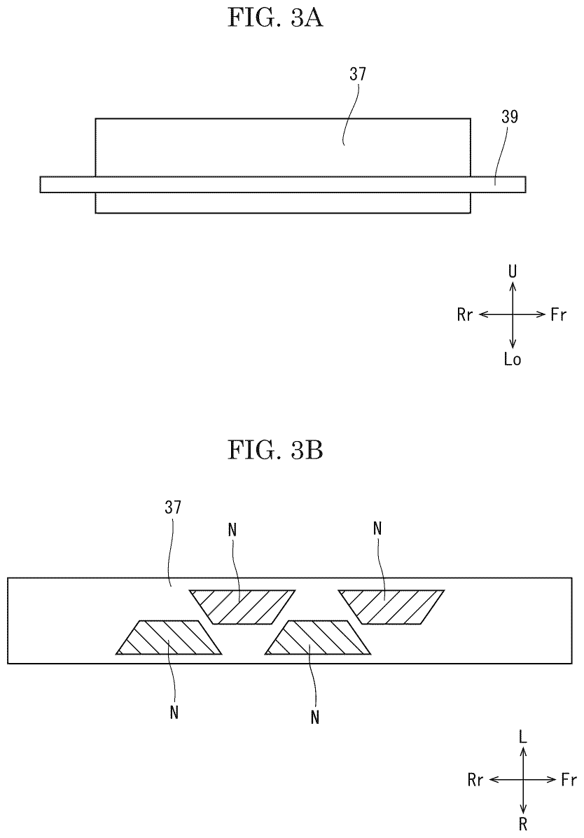

The inkjet head 37 will be described with reference to FIG. 3A and FIG. 3B. FIG. 3A is a side view showing the inkjet head 37, and FIG. 3B is a bottom view showing the inkjet head 37. The inkjet head 37 has a rectangular parallelepiped shape elongated in a width direction (the front-and-rear direction) intersecting the conveying direction of the sheet S. The inkjet head 37 has a large number of nozzles (not shown) to which the ink is supplied, and a piezoelectric element (not shown) provided for each nozzle. The ejection ports of the nozzles are opened on the lower surface of the inkjet head 37. When the piezoelectric element is driven, the ink in the nozzle is ejected downward through the ejection port of the nozzle. As shown in FIG. 3B, the region where the ejection ports are opened refers to as a nozzle surface N.

The three inkjet heads 37 are arranged in a staggered pattern along the width direction, as shown in FIG. 2A, and are supported on the plate 39 such that the lower end portion protrudes downward from the plate 39, as shown in FIG. 3A.

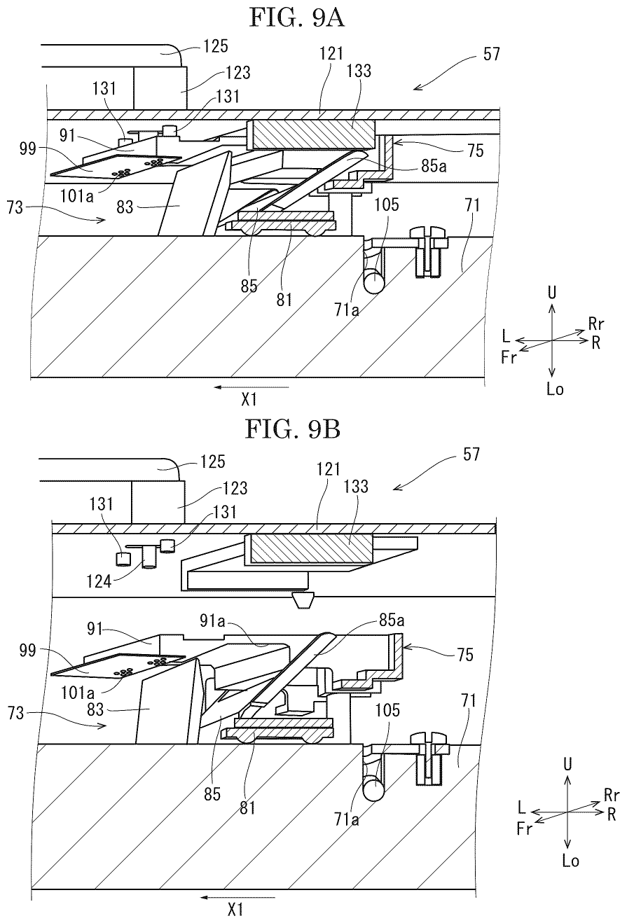

Each head unit 11 is supported by a head unit moving mechanism 41 (not shown in FIG. 1, FIG. 2A and FIG. 2B, see FIG. 9) to be moved in the upper-and-lower direction between a printing position and a retracted position. The printing position is a position where the nozzle surface N of the inkjet head 37 of each head unit 11 faces the conveying belt 25 traveling along the upper track with a predetermined interval (for example, 1 mm) (see FIG. 1). The retracted position is a position where the head unit 11 is separated more upward than the printing position to form a space in which a cap unit 51 and a wipe unit 53 of the maintenance device 13, which will be described later, can be accommodated above the conveying unit 9. The printing position is a home position of the head unit 11. The head unit moving mechanism 41 (see FIG. 9) is electrically connected to a control part 201 (see FIG. 1 and FIG. 9).

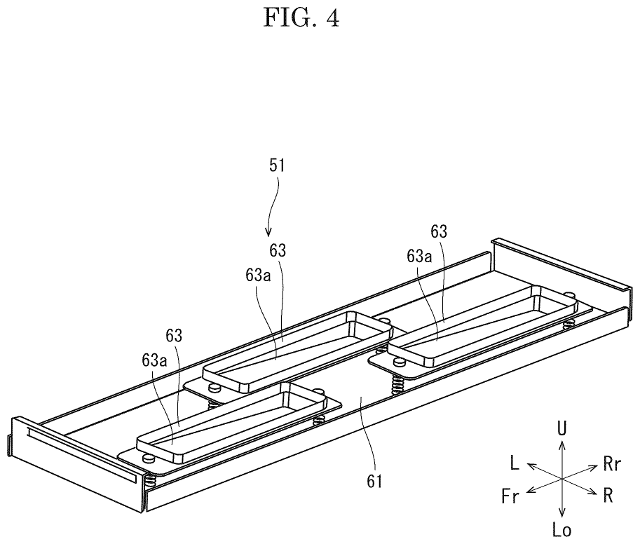

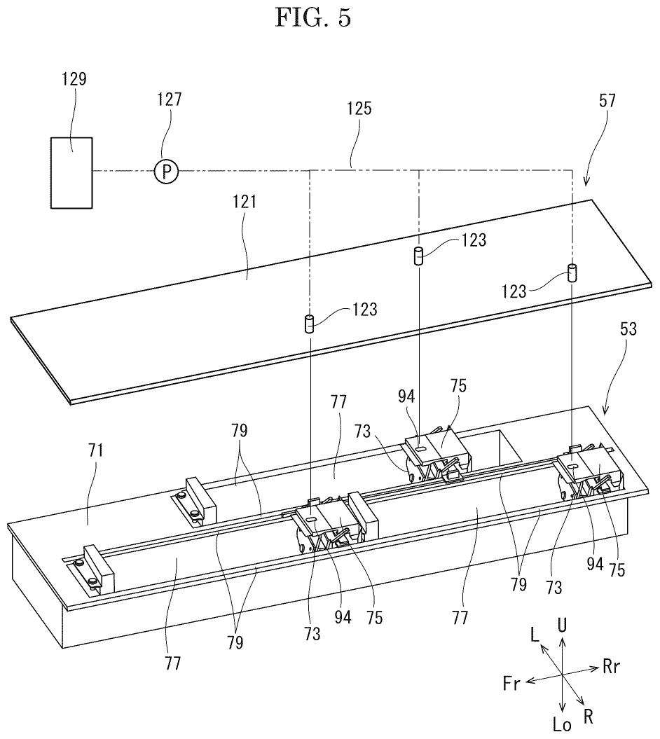

Next, the maintenance device 13 will be described with reference to FIG. 4 and FIG. 5. FIG. 4 is a perspective view showing the cap unit 51, and FIG. 5 is a perspective view showing the wipe unit 53 and a cleaning liquid supply mechanism 57. The maintenance device 13 includes the cap unit 51 (see FIG. 4), the wipe unit 53 (see FIG. 5), a housing 55 (see FIG. 2A and FIG. 2B) in which the cap unit 51 and the wipe unit 53 are housed, and the cleaning liquid supply mechanism 57 (see FIG. 5) which supplies a cleaning liquid to the wipe unit 53. The maintenance device 13 is provided for each head unit 11, and is arranged adjacent to the corresponding head unit 11 in the conveying direction. In this example, as shown in FIG. 2A and FIG. 2B, the head unit is arranged on the left side (the downstream side in the conveying direction of the sheet S) of the corresponding head unit 11.

First, the housing 55 (see FIG. 2B) will be described. The housing 55 has a rectangular parallelepiped shape elongated in the width direction. The upper surface and the right surface of the housing 55 (the surface facing the corresponding head unit 11) are opened. The maintenance device 13 may be arranged on the right side (the upstream side in the conveying direction) of the corresponding head unit 11. In this case, the left surface of the housing 55 is opened.

Next, the cap unit 51 will be described with reference to FIG. 4. The cap unit 51 includes a support plate 61 and three caps 63 supported on the support plate 61. The support plate 61 has a rectangular shape elongated in the width direction. The three caps 63 are arranged in a staggered pattern along the width direction, in the same manner as the three inkjet heads 37 of the head unit 11. Each cap 63 includes a recess 63a having an open upper surface, and a discharge port (not shown) provided at the bottom of the recess 63a. The recess 63a has a size that surrounds the nozzle surface N of one inkjet head 37.

The cap unit 51 is housed in the lower space of the housing 55 as shown in FIG. 2B. The cap unit 51 can be moved between a separated position (see FIG. 2B) housed in the housing 55 and a capping position pulled out from the housing 55 rightward through the opening of the housing 55 by a cap unit moving mechanism (not shown).

Next, the wipe unit 53 and the cleaning liquid supply mechanism 57 will be described with reference to FIG. 5. First, the wipe unit 53 will be described. The wipe unit 53 includes a support plate 71, three carriages 73, three cleaning liquid supply members 75, and three waste liquid trays 77.

The support plate 71 is provided with three pairs of rails 79 along the width direction. The three pairs of rails 79 are arranged in a staggered pattern along the width direction, in the same manner as the three inkjet heads 37 of the head unit 11.

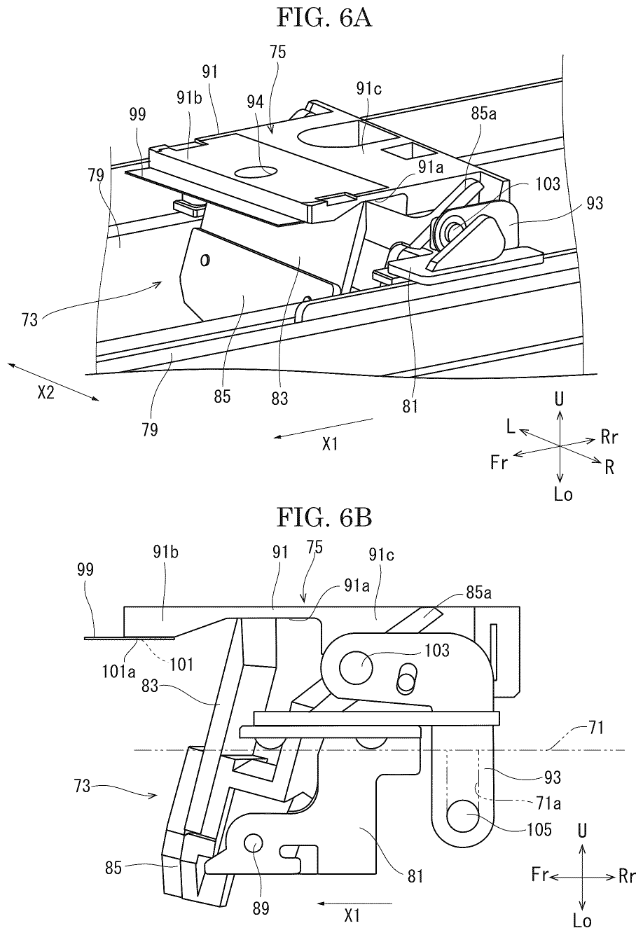

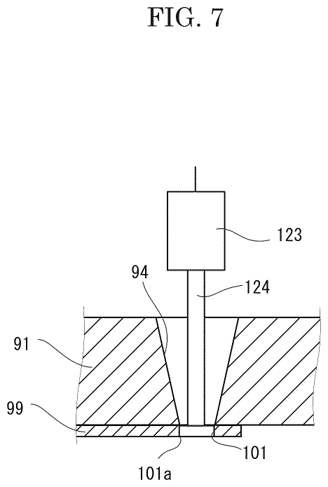

Next, the carriage 73 and the cleaning liquid supply member 75 will be described with reference to FIG. 6A, FIG. 6B, and FIG. 7. FIG. 6A is a perspective view showing the carriage 73 and the cleaning liquid supply member 75, FIG. 6B is a side view showing the carriage 73 and the cleaning liquid supply member 75. FIG. 7 is a side view schematically showing a cleaning liquid storage member 91 of the cleaning liquid supply member 75.

First, the carriage 73 will be described. As shown in FIG. 6A and FIG. 6B, the carriage 73 includes a moving body 81, a blade 83, and a holder 85 that supports the blade 83 and is supported by the moving body 81. The moving body 81 is engaged with the rails 79 formed on the support plate 71, and can be moved along the rails 79 between a moving start position and a moving end position by a carriage moving mechanism 87 (not shown in FIG. 6A and FIG. 6B, see FIG. 9). The moving start position and the moving end position are positions on both outer sides of the nozzle surface N of the inkjet head 37 in the width direction (the front-and-rear direction). In this example, the moving start position is a position on the rear side of the nozzle surface N, and the moving ending position is a position on the front side of the nozzle surface N. The direction from the moving start position to the moving end position (in this example, the direction from the rear to the front) is defined as a moving direction X1 of the carriage 73. The moving start position is a home position of the carriage 73. The carriage moving mechanism 87 is electrically connected to the control part 201 (see FIG. 9).

The blade 83 is a plate-like member having a width wider than the width of the nozzle surface N, and is made of flexible resin or the like. The blade 83 takes a posture inclined on the upstream side in the moving direction X1 (the front-and-rear direction) and inclined in a blade width direction X2 (the left-and-right direction) intersecting the moving direction X1, and the lower end portion of the blade 83 is supported by the holder 85. The lower end portion of the holder 85 is supported by the moving body 81 so as to be rotatable around a turning shaft 89 (see FIG. 6B) on the upstream side of the blade 83 in the moving direction X1. Thereby, the blade 83 can be turned to the upstream side and the downstream side of the moving direction X1 around the turning shaft 89 together with the holder 85. The holder 85 has a pair of arms 85a which extend upward and are spaced apart in the blade width direction X2.

Next, the cleaning liquid supply member 75 will be described. The cleaning liquid supply member 75 is provided separately from the carriage 73, and includes a cleaning liquid storage member 91 and a pair of holders 93 which support the cleaning liquid storage member 91 and are supported by the support plate 71. The cleaning liquid storage member 91 is a rectangular plate-like member, and has a flat upper surface. On the lower surface of the cleaning liquid storage member 91, a recess 91a is formed along the blade width direction X2. The downstream side surface of the recess 91a in the moving direction X1 is inclined toward the downstream side of the moving direction X1. The cleaning liquid storage member 91 has a tip end portion 91b on the downstream side of the recess 91a in the moving direction X1 and a base end portion 91c on the upstream side of the recess 91a in the moving direction X1. The tip end portion 91b is formed to be thinner than the base end portion 91c.

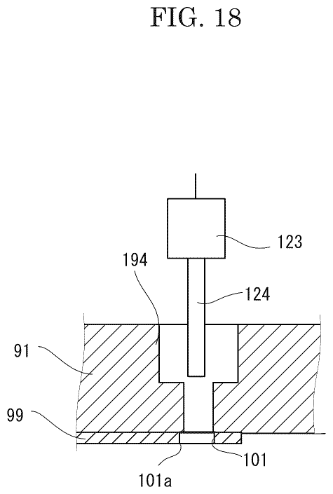

The lower surface of the tip end portion 91b is formed to be planar. As shown in FIG. 6A and FIG. 7, one or more supply holes 94 penetrating in the upper-and-lower direction are formed in the tip end portion 91b. The supply hole 94 is opened on the lower surface of the tip end portion 91b. The cross-sectional shape of the supply hole 94 may be circular. The inner dimension of the supply hole 94 may be increased upward. The supply hole 94 has no horizontal flat surface in the middle, or even if the supply hole 94 has a horizontal flat surface in the middle, as shown in FIG. 18, the area of the flat surface is not more than 10 times, preferably not more than 5 times, the area of the narrowest cross-section of the supply hole 194. That is, when the cleaning liquid is supplied into the supply hole 94, almost all of the cleaning liquid enters the supply hole 94 once, and the cleaning liquid that does not fall from the cleaning liquid storage member 91 is held inside the supply hole 94 and on the lower surface of the cleaning liquid storage member 91 (a sheet member 99, as described below). Further, the sheet member 99 protruding to the downstream side of the moving direction X1 may be attached on the lower surface of the tip end portion 91b. The sheet member 99 has a through-hole 101 (see also FIG. 6B) communicating with the supply hole 94 of the tip end portion 91b. The through-hole 101 is opened on the lower surface of the sheet member 99. The lower surface of the sheet member 99 to which the through-hole 101 is opened is an example of the cleaning liquid supply surface of the present disclosure. A plurality of the supply holes 94 may be formed along the blade width direction X2. In this case, the sheet member 99 has a plurality of the through-holes 101 communicating with the supply holes 94.

Each of the holders 93 is an L-shaped plate-like member viewed from the side surface. One end portion of the holder 93 is rotatably supported on the side surface of the base end portion 91c of the cleaning liquid storage member 91 within a predetermined range around a turning shaft 103. The other end portion of the holder 93 is rotatably supported on the support plate 71 around a turning shaft 105 (see FIG. 6B) on the upstream side of the carriage 73, which is moved to the moving start position, in the moving direction X1. Specifically, the turning shaft 105 is housed in a recess 71a provided in the support plate 71. As a result, the holder 93 can be turned upward and downward around the turning shaft 105, and when it is turned upward, the cleaning liquid storage member 91 is turned upward together with the holder 93, and when it is turned downward, the cleaning liquid storage member 91 is turned downward together with the holder 93. A torsional coil spring (not shown) is fitted around the turning shaft 105. The torsional coil spring biases the holder 93 to be turned downward. The arms 85a of the holder 85 of the carriage 73 extend upward through the spaces between the base end portion 91c of the cleaning liquid storage member 91 and the holders 93.

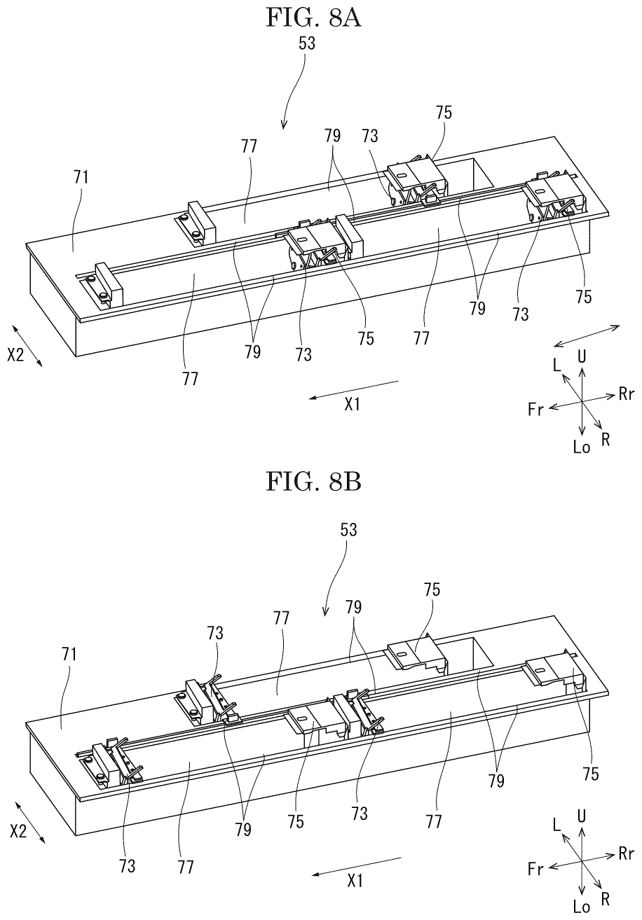

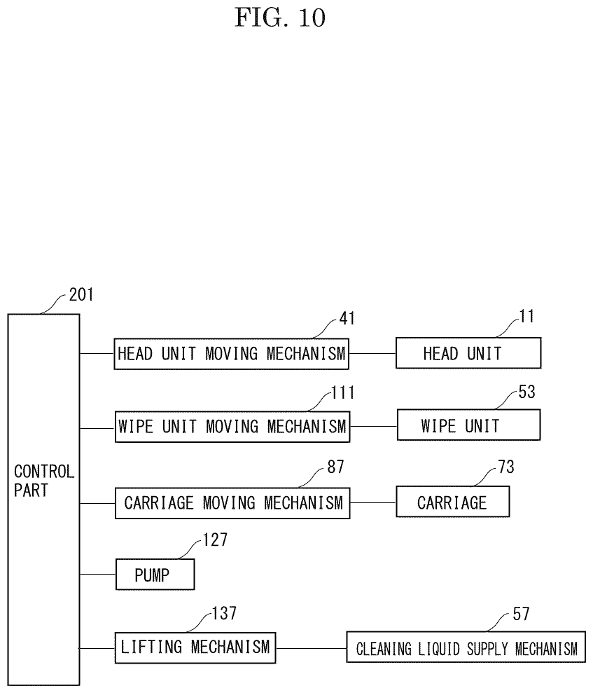

The movement of the carriage 73 will be described with reference to FIG. 8A and FIG. 8B. FIG. 8A and FIG. 8B are perspective views showing the wipe unit 53. FIG. 8A shows the carriages 73 moved to the moving start position, and FIG. 8B shows the carriages 73 moved to the moving end position. As shown in FIG. 8A, when the carriage 73 is moved to the moving start position, the tip end of the blade 83 is accommodated in the recess 91a of the cleaning liquid storage member 91 (see also FIG. 6A and FIG. 6B). The carriage 73 is moved from the moving start position to the moving end position shown in FIG. 8B by a carriage moving mechanism 87 (see FIG. 10). Since the cleaning liquid supply member 75 is immovably supported by the support plate 71 as described above, the cleaning liquid supply member 75 does not move even if the carriage 73 is moved.

As shown in FIG. 2B, the wipe unit 53 is housed in the upper space of the housing 55. The wipe unit 53 can be moved from a separated position housed in the housing 55 (see FIG. 2B) to a wiping position pulled out rightward from the housing 55 through the opening of the housing 55 by a wipe unit moving mechanism 111 (not shown in FIG. 2B, see FIG. 10). As will be described later, at the wiping position, each blade 83 of the wipe unit 53 can be in contact with the nozzle surface N of the inkjet head 37, and at the separated position, each blade 83 of the wipe unit 53 is separated from the nozzle surface N of the inkjet head 37. The separated position is a home position of the wipe unit 53. The wipe unit moving mechanism 111 is electrically connected to the control part 201 (see FIG. 10).

Next, the cleaning liquid supply mechanism 57 will be described with reference to FIG. 5, FIG. 9A and FIG. 9B. FIG. 9A and FIG. 9B are side views showing the cleaning liquid supply mechanism 57 moved to a separated position and a supply position.

The cleaning liquid supply mechanism 57 supplies the cleaning liquid (for example, water) to each cleaning liquid supply member 75 of the wipe unit 53. As shown in FIG. 5, the cleaning liquid supply mechanism 57 includes a support plate 121 and three supply pipes 123 supported on the support plate 121. The support plate 121 is a rectangular member having the same size as the support plate 71 of the wipe unit 53. The three supply pipes 123 are arranged so as to correspond to the supply holes 94 of the cleaning liquid storage members 91 of the three cleaning liquid supply members 75 of the wipe unit 53, and the lower end portion of the supply pipe 123 protrudes downward from the support plate 121. The supply pipe 123 is an example of the supply path along which the cleaning liquid is suppled to the wipe unit 53.

At the lower end portion of each supply pipe 123, a supply part 124 having a through-hole along the longitudinal direction is provided. The supply part 124 has an outer dimension smaller than the outer dimension of the supply pipe 123 and the upper end portion of the supply hole 94 formed in the tip end portion 91b of the cleaning liquid storage member 91 of the cleaning liquid supply member 75. The outer shape of the supply part 124 may be cylindrical.

The upper end portions of the three supply pipes 123 are connected to pipes 125. The pipes 125 are connected to a cleaning liquid tank 129 via a pump 127. When the pump 127 is driven, the cleaning liquid is pumped from the cleaning liquid tank 129 and supplied to the supply pipes 123 through the pipes 125. The pump 127 is electrically connected to the control part 201 (see FIG. 10).

Further, as shown in FIG. 9A and FIG. 9B, on the lower surface of the support plate 121, a pair of cylindrical positioning pins 131 are formed on both sides of the supply pipe 123 in the blade width direction X2. Further, on the lower surface of the support plate 121, a pair of rectangular parallelepiped protrusions 133 separated in the blade width direction X2 are formed on the upstream side of the supply pipe 123 in the moving direction X1.

The cleaning liquid supply mechanism 57 is supported movably in the upper-and-lower direction to a plurality of positions including an insertion position (see FIG. 9A) and a separated position (see FIG. 9B) by a lifting mechanism 137 (not shown in FIG. 5, FIG. 9A and FIG. 9B, see FIG. 10). As shown in FIG. 9A, at the insertion position, the pair of positioning pins 131 abut on the upper surface of the tip end portion 91b of the cleaning liquid storage member 91, and the supply part 124 of the supply pipe 123 is inserted into the supply hole 94 of the cleaning liquid storage member 91. At the insertion position, the tip end of the supply part 124 is positioned at any position from a position that is the same height as the upper end of the supply hole 94 (for convenience, this position is included in the insertion position) to a position that is the same height as the lower surface of the cleaning liquid storage member 91 (the opening of the supply hole 94). If the sheet member 99 is provided, the tip end of the supply part 124 may be inserted until it reaches the same surface as the lower surface (the through-hole 101) of the sheet member 99. Further, the protrusions 133 push down the arms 85a of the holder 85 of the carriage 73. As a result, the holder 85 is turned with respect to the moving body 81, and the blade 83 is inclined to the upstream side of the moving direction X1. Further, as shown in FIG. 9B, at the separated position, the supply part 124 of the supply pipe 123 is separated upward from the supply hole 94. The lifting mechanism 137 is electrically connected to the control part 201 (see FIG. 10).

The lifting mechanism 137 may move the cleaning liquid supply mechanism 57 to a penetration position where the tip end of the supply part 124 of the supply pipe 123 protrudes from the supply hole 94, in addition to the insertion position and the separated position. If the sheet member 99 is provided, at the penetration position, the tip end of the supply part 124 protrudes from the through-hole 101 of the sheet member 99.

As shown in FIG. 5, the waste liquid tray 77 is disposed below the moving area of the carriage 73, and is supported by the support plate 71.

Next, the control part 201 will be described with reference to FIG. 10. FIG. 10 is a block diagram showing the control part 201. The control part 201 operates the head unit moving mechanism 41 to move the head unit 11 along the upper-and-lower direction to a plurality of positions including the printing position and the retracted position. The control part 201 operates the carriage moving mechanism 87 to move the carriage 73 between the moving start position and the moving end position. The control part 201 operates the wipe unit moving mechanism 111 to move the wipe unit 53 between the wiping position and the separated position along the left-and-right direction. The control part 201 operates the pump 127 to start and stop pumping of the cleaning liquid from the cleaning liquid tank 129. The control part 201 operates the lifting mechanism 137 to move the cleaning liquid supply mechanism 57 along the upper-and-lower direction to a plurality of positions including the insertion position and the separated position.

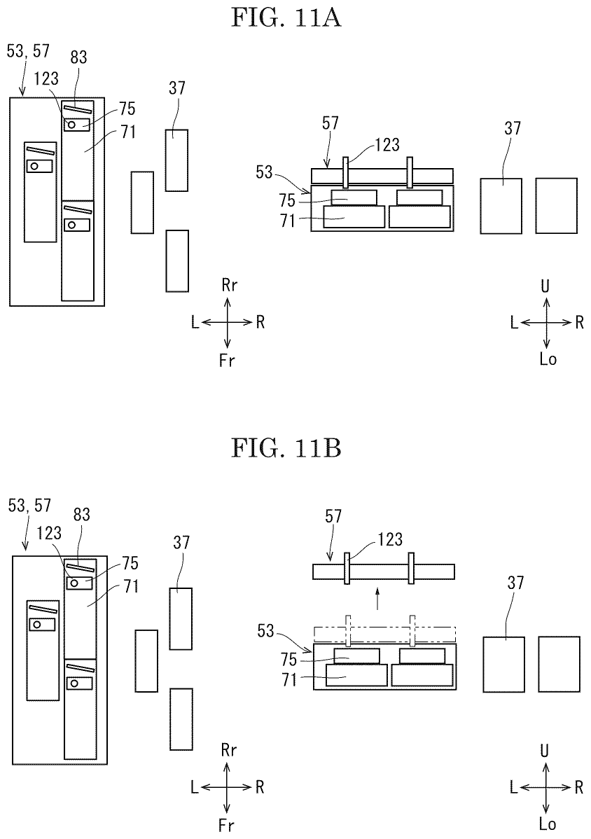

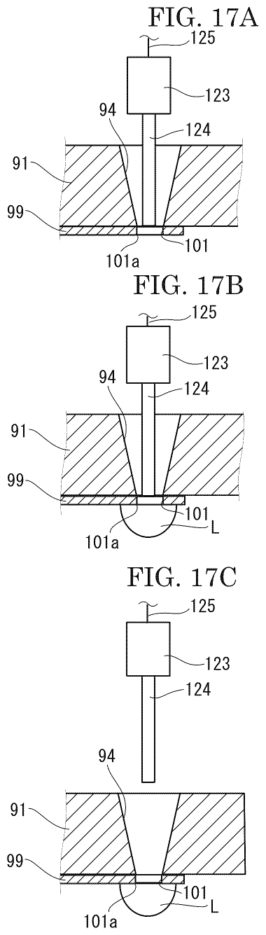

In the inkjet recording apparatus 1 having the above configuration, an image forming operation and a wiping operation by the maintenance device 13 will be described mainly with reference to FIG. 11A to FIG. 17C. FIG. 11A to FIG. 16 are views schematically showing the wipe unit 53 and the inkjet head 37, the left side of each drawing is a plan view, and the right side of each view is a front view. FIG. 17A to FIG. 17C schematically show a process of supplying the cleaning liquid from the supply pipe 123 of the cleaning liquid supply mechanism 57. FIG. 11A to FIG. 16 do not show the supply part 124. Description of the capping operation is omitted.

The image forming operation and the wiping operation are performed by the control t 201 controlling each moving mechanism, the pump, and the others. In the initial state, the head unit 11, the wipe unit 53, the carriage 73, and the cleaning liquid supply mechanism 57 are moved to the respective home positions. That is, the head unit 11 is moved to the printing position, the wipe unit 53 is moved to the separated position, the carriage 73 is moved to the moving start position, and the cleaning liquid supply mechanism 57 is moved to the insertion position.

First, the image forming operation will be described. When an image forming job is input to the inkjet recording apparatus 1 from an external computer or the like, the sheet S is fed from the sheet feeding cassette 5 to the conveyance path 19 by the sheet feeding roller 7. The fed sheet S is conveyed to the conveying unit 9 at a predetermined timing after the skew is corrected by the registration rollers pair 23. The sheet S is attracted to the conveying belt 25, and conveyed in the conveying direction. At this time, when the control part 201 supplies gradation data corresponding to each nozzle of the head unit 11 to a drive circuit in synchronization with the conveyance of the sheet S, the drive circuit supplies a drive signal corresponding to the gradation data to the piezoelectric element, thereby ejecting the ink drops from the nozzle and forming an image on the sheet S. The sheet S on which the image is formed is discharged to the discharge tray 17 by the discharge rollers pair 15.

In this way, the head unit 11 is moved to the printing position during the image forming operation. As shown in FIG. 3B, each inkjet head 37 of the head unit 11 is not provided with a structure for supplying the cleaning liquid. Therefore, a defect such that the cleaning liquid comes into contact with the sheet S accidentally does not occur.

Next, the wiping operation will be described. As shown in FIG. 11A, in the initial state, the wipe unit 53 is moved to the separated position, the carriage 73 (the blade 83) is moved to the moving start position, and the cleaning liquid supply mechanism 57 is moved to the insertion position. That is, as shown in FIG. 17A, the supply part 124 of each supply pipe 123 of the cleaning liquid supply mechanism 57 is inserted into the supply hole 94 of each cleaning liquid supply member 75 of the wipe unit 53. Specifically, the tip end of the supply part 124 reaches the lower end of the supply hole 94 or the through-hole 101. Further, the protrusions 133 of the cleaning liquid supply mechanism 57 push down the arms 85a of the holder 85 of the carriage 73, so that the blade 83 is inclined upstream in the moving direction X1 (see FIG. 9A).

Next, the control part 201 operates the pump 127. Thus, the cleaning liquid is pumped from the cleaning liquid tank 129, and supplied from the supply parts 124 through the tubes 125 and the supply pipes 123. The control part 201 stops driving the pump 127 after a predetermined time has elapsed. Then, as shown in FIG. 17B, the cleaning liquid supplied from each supply part 124 is in contact with the inner wall of the supply hole 94, wets the inner wall, passes through the through-hole 101 of the sheet member 99, flows downward from the opening 101a of the through-hole 101, and is held as a droplet by wetting with the inner wall of the supply hole 94 and wetting with the sheet member 99 to form a downward protruded meniscus L.

Next, as shown in FIG. 11B, the control part 201 operates the lifting mechanism 137 to lift the cleaning liquid supply mechanism 57 from the insertion position to the separated position. As a result, as shown in FIG. 17C, the supply part 124 is separated upward from the supply hole 94 of the cleaning liquid storage member 91. On the other hand, the cleaning liquid L having the downward protruded meniscus is held in the opening 101a.

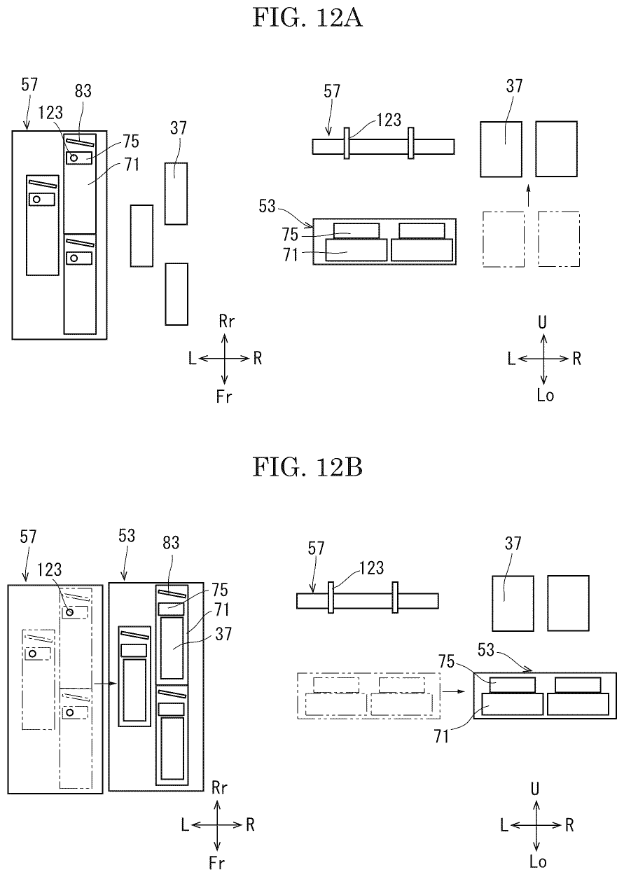

Thereafter, as shown in FIG. 12A, the control part 201 operates the head unit moving mechanism 41 to move the head unit 11 (the inkjet head 37) from the printing position to the retracted position. Thereafter, as shown in FIG. 12B, the control part 201 operates the wipe unit moving mechanism 111 to move the wipe unit 53 from the separated position to the wiping position. That is, the wipe unit 53 is separated from the space below the cleaning liquid supply mechanism 57. At this time, the wipe unit 53 is moved while holding the cleaning liquid having the downward protruded meniscus on the opening 101a of the through-hole 101 of the sheet member 99 (see FIG. 6A and FIG. 6B). While the wipe unit 53 is moving, the waste liquid tray 77 is being kept at a position below the cleaning liquid storage member 91, so that even if the cleaning liquid falls from the cleaning liquid storage member 91, it is received by the waste liquid tray 77. Thus, the conveyed sheet S, the conveying belt 25, and the inside of the inkjet recording apparatus 1 can be suppressed from being wetted by the cleaning liquid.

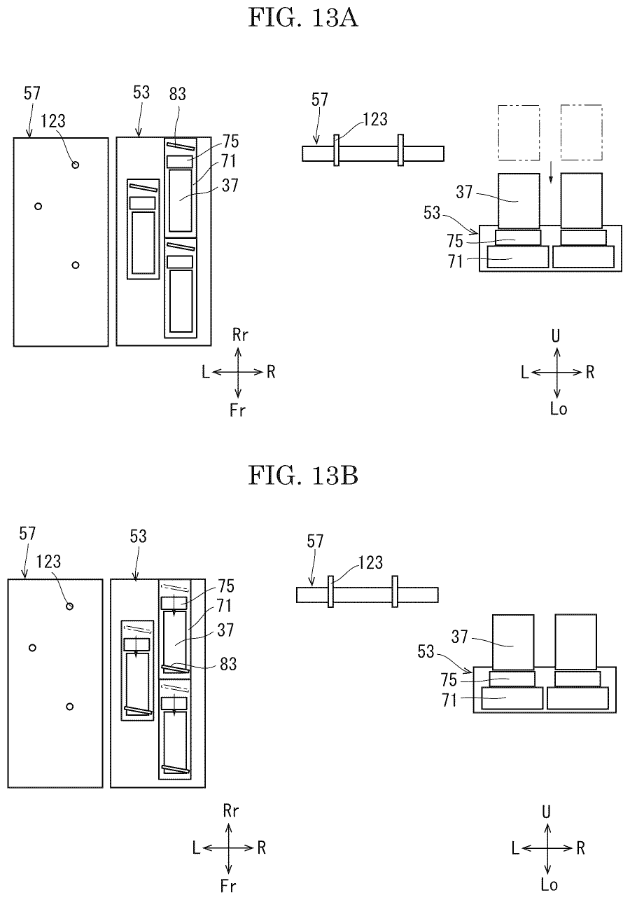

Next, as shown in FIG. 13A, the control part 201 operates the head unit moving mechanism 41 to lower the head unit 11 so that the lower surface (the nozzle surface N) of each inkjet head 37 is on the same plane as the lower surface of the tip end portion 91b of each cleaning liquid storing member 91 of the wipe unit 53. Then, the carriage 73 of the wipe unit 53 is positioned at the moving start position (a position on the upstream side of the nozzle surface N in the moving direction X1), and the upper surface of the sheet member 99 of the carriage 73 abuts on the lower surface of the inkjet head 37. The sheet member 99 seals a gap between the lower surface of the inkjet head 37 and the lower surface of the tip end portion 91b of the cleaning liquid storage member 91.

Next, as shown in FIG. 13B, the control part 201 operates the carriage moving mechanism 87 to move the carriage 73 from the moving start position to the moving end position. Then, the blade 83 is moved together with the carriage 73. The blade 83 first elastically deforms and bends to the upstream side in the moving direction X1 along the side surface of the recess 91a of the cleaning liquid storage member 91, and when it reaches the lower surface of the tip end portion 91b, wipes off the cleaning liquid having the downward protruded meniscus held in the openings 101a. At this time, the tip end portion 91b of the cleaning liquid storage member 91 is pushed up by the blade 83, the cleaning liquid storage member 91 is turned upward with respect to the holder 93 around the turning shaft 103, and the holder 93 is turned upward around the turning shaft 105 (see FIG. 6A and FIG. 6B).

Thereafter, the blade 83 is moved along the nozzle surface N of the inkjet head 37 through the sheet member 99 together with the cleaning liquid. Then, the ink adhered on the nozzle surface N is wiped off. The wiped ink and cleaning liquid falls into the lower waste liquid tray 77. As described above, the cleaning liquid supply member 75 has not moved. When the blade 83 is separated from the sheet member 99, the holder 93 is biased by the torsion coil spring and turned downward.

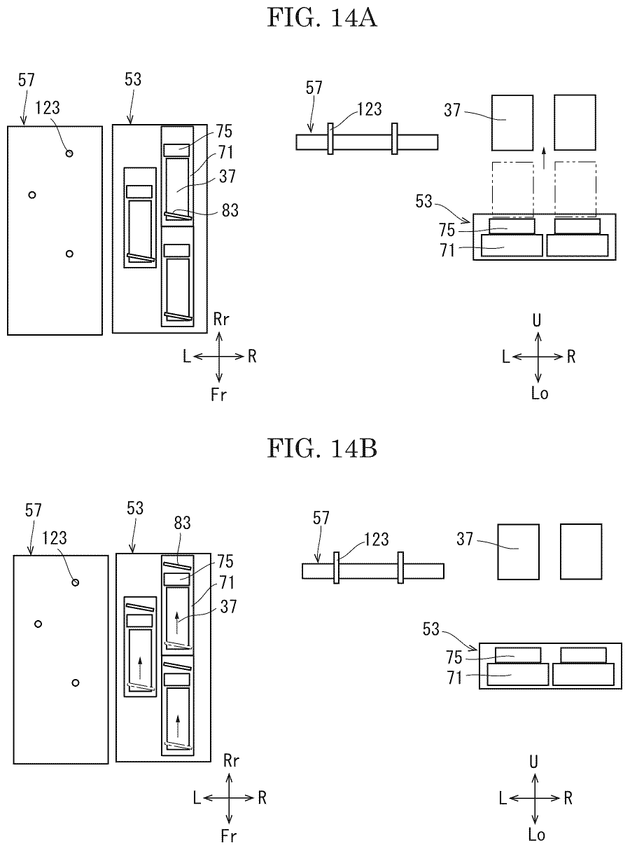

Next, as shown in FIG. 14A, the control part 201 operates the head unit moving mechanism 41 to move the head unit 11 (the inkjet head 37) to the retracted position. Thus, the nozzle surface N of each inkjet head 37 is separated upward from the blade 83. Thereafter, as shown in FIG. 14B, the control part 201 operates the carriage moving mechanism 87 to return the carriage 73 from the moving end position to the moving start position. Thereafter, the aforementioned wiping operation may be repeated as necessary.

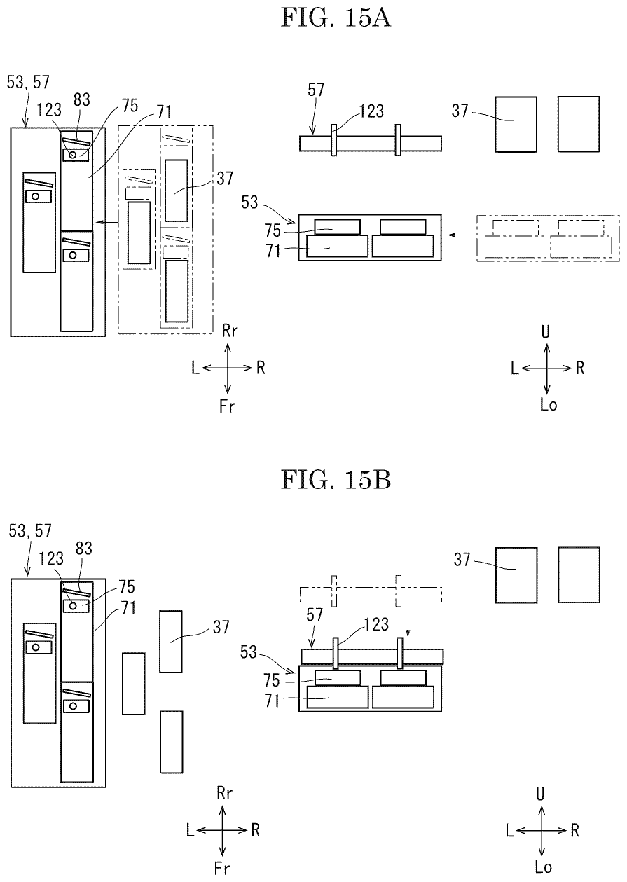

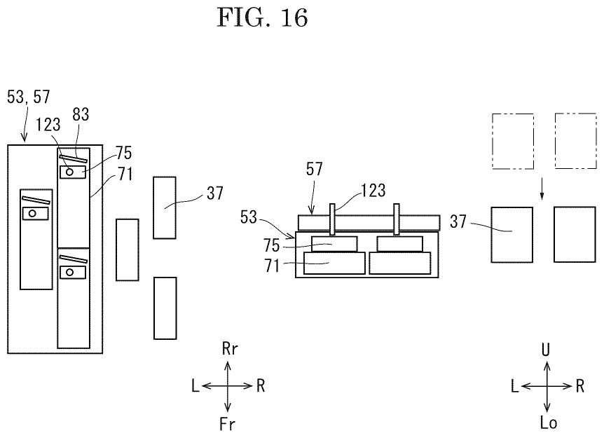

After the wiping operation is finished, as shown in FIG. 15A, the control part 201 operates the wipe unit moving mechanism 111 to move the wipe unit 53 from the wiping position to the separated position (the home position), and then, as shown in FIG. 15B, the control part 201 operates the lifting mechanism 137 to lower the cleaning liquid supply mechanism 57 from the separated position to the insertion position. At this time, the supply part 124 of the supply pipe 123 is inserted into the supply hole 94 of the cleaning liquid storage member 91 of the cleaning liquid supply member 75 of the carriage 73. Since the dimension of the supply hole 94 is increased upward, it is easy to insert the supply part 124 into the supply hole 94. The outer dimension of the supply part 124 may be larger than the smallest inner dimension of the supply hole 94 to cope with the positional deviation between the wipe unit 53 and the cleaning liquid supply mechanism 57. Next, as shown in FIG. 16, the control part 201 operates the head unit moving mechanism 41 to lower the head unit 11 (the inkjet head 37) from the retracted position to the printing position (the home position).

As described above, according to the present disclosure, in a state where the supply part 124 of the supply pipe 123 of the cleaning liquid supply mechanism 57 is inserted into the supply hole 94 of the cleaning liquid storage member 91 (the insertion position), the cleaning liquid is supplied to the supply hole 94 from the supply part 124. Therefore, the cleaning liquid does not leak out from the supply pipe 123 and adhere to the surrounding members. Further, if the cleaning liquid is suppled in a state where the supply part 124 is not inserted into the supply hole 94, that is, in a state where the supply part 124 is above the tip end portion 91b, because some cleaning liquid does not enter the supply hole 94 and remains on the tip end portion 91b, the amount of the cleaning liquid flowing down from the supply hole 94 is not constant, and the amount of the cleaning liquid stored on the lower surface of the cleaning liquid storage member 91 is difficult to be constant. When the cleaning liquid is supplied in the state that the supply part 124 is inserted into the supply hole 94, such a situation is difficult to occur and the amount of the supplied cleaning liquid becomes constant. Further, the cleaning liquid storage member 91 can hold a predetermined amount of the cleaning liquid supplied from the cleaning liquid supply mechanism 57. Further, the supply hole 94 is formed so that the inner dimension is increased upward. Therefore, the supply part 124 can be securely inserted into the supply hole 94. The supply hole 94 may have a small dimension portion smaller than the outer dimension of the supply part 124 except for the upper end of the supply hole 94. The position of the smallest dimension portion of the supply hole 94 may be at the lower end of the supply hole 94 or at a portion extending upward from the lower end with the same dimension as the lower end. Since the supply hole 94 has the small dimension portion smaller than the supply part 124, the tip end of the supply part 124 is located near the inner wall of the supply hole 94 at the insertion position, and the cleaning liquid supplied from the supply part 124 easily flows down along the inner wall of the supply hole 94. If the cleaning liquid falls without contacting with the inner wall of the supply hole 94, the cleaning liquid may fall without being stored on the lower surface of the cleaning liquid storage member 91, but such a possibility can be reduced by contacting the cleaning liquid with the inner wall of the supply hole 94. At the insertion position, the tip end of the supply part 124 may be in contact with the supply hole 94.

The wipe unit 53 includes the blade 83 and the cleaning liquid supply member 75, and is moved to the separated position during the image forming operation. That is, since the head unit 11 is not provided with the cleaning liquid supply member 75, the cleaning liquid supplied from the cleaning liquid supply member 75 does not adhere to the sheet S or the sheet S does not come into contact with the cleaning liquid supply member 75 even when the sheet S is accidentally bent upward during the image forming operation. Therefore, contamination of the sheet S by the cleaning liquid and damage to the cleaning liquid supply member 75 by the sheet S can be prevented.

The cleaning liquid supply mechanism 57 can be moved to the insertion position and the penetration position by the lifting mechanism 137. The cleaning liquid may be supplied at an intermediate insertion position where the tip end of the supply part 124 is located in the middle of the supply hole 94. Since the cleaning liquid supplied from the supply part 124 can be supplied from the middle to the lower portion of the supply hole 94, a relatively large amount of the cleaning liquid can be supplied. At the penetration position, if the cleaning liquid contains bubbles or the like, the cleaning liquid containing the bubbles can be discharged without contacting with the supply hole 94. That is, when the bubbles or the like are discharged, the cleaning liquid discharged from the supply part 124 is prevented from accumulating in the supply hole 94 and on the lower surface of the cleaning liquid supply member 75. The cleaning liquid discharged at this time is received by the lower waste liquid tray 77. Before supplying the cleaning liquid to be accumulated in the supply hole 94 and on the lower surface of the cleaning liquid supply member 75, the supply part 124 is arranged at the penetration position and the cleaning liquid is supplied, so that the bubbles or the like in the supply part 124 can be discharged. Thereafter, the supply part 124 is moved to the insertion position, and the cleaning liquid is supplied to the supply hole 94, whereby the amount of the supplied cleaning liquid can be constant.

A plurality of the supply holes 94 may be formed in the cleaning liquid storage member 91. In this case, the cleaning liquid supply mechanism 57 includes the supply pipe 123 and the supply part 124 for each supply hole 94. In this case, it becomes possible to increase the amount of the suppled cleaning liquid.

Further, the supply pipe 123 of the cleaning liquid supply mechanism 57 for supplying the cleaning liquid to the cleaning liquid supply member 75 is only moved to the supply position and the separated position in the upper-and-lower direction, but is not moved in the horizontal direction. Therefore, since the moving distance of the supply pipe 123 is relatively short, it is possible to prevent the pipes 125 connected to the supply pipe 123 from bending and then causing a supply failure. Further, the pipe 125 can be pulled in a narrow space.

Next, a modified example of the present disclosure will be described with reference to FIG. 18. In this modified example, as shown in FIG. 18, the supply hole 194 is non-continuously narrowed on the way downward. In other words, the inner dimension of the supply hole 94 is sharply narrowed. In the portion where the inner dimension is sharply narrowed, a step may be formed, and a horizontal flat portion may be formed. In the narrowed portion on the lower end side of the supply hole 194, the inner dimension may be smaller than the outer dimension of the tip end of the supply part 124. In such a case, when the supply part 124 supplies the cleaning liquid at the insertion position, the cleaning liquid is supplied near the flat portion, so that it is difficult for the cleaning liquid to fall from the cleaning liquid supply member 75 without contacting with the inner wall of the supply hole 194. Further, since the flow momentum of the cleaning liquid is weakened when the cleaning liquid hits the flat portion, the cleaning liquid cannot fall from the cleaning liquid supply member 75 unnecessarily. When the supply part 124 supplies the cleaning liquid at the insertion position, the tip end of the supply part 124 may be brought into contact with the flat portion.

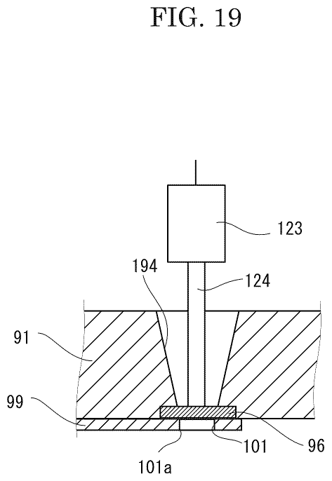

Next, another modified example of the present disclosure will be described with reference to FIG. 19. In this modified example, as shown in FIG. 19, a mesh member 96 is provided inside the opening of the supply hole 94. The mesh size of the mesh member 96 is smaller than the smallest inner dimension of the supply hole 194. The supply part 124 is inserted until its tip is in contact with the mesh member 96.

According to the example, since the mesh member 96 whose mesh size is smaller than the smallest inner dimension of the supply hole 94 is provided in the opening where the supply hole 94 faces the cleaning liquid supply surface, the flow path resistance of the supply hole 94 is enhanced. Thus, the momentum of the cleaning liquid supplied from the supply part 124 is buffered, and the cleaning liquid is easily held in the mesh member 96 and the opening 101a.

In this embodiment, an example in which the four head units 11 are provided for the colors of ink and the maintenance device 13 is provided for each head unit 11 is described. However, the four head units 11 may be integrally provided, and the maintenance device 13 may be configured such that the four cap units 51 and the four wipe units 53 are integrally provided.

In the present embodiment, an example in which the head unit 11 is configured to be moved to the printing position and the retracted position in the upper-and-lower direction while the conveying unit 9 is configured to be not moved is described. However, the conveying unit 9 may be configured to be moved to the printing position and the retracted position in the upper-and-lower direction while the head unit 11 may be configure to be not moved. In this case, the maintenance device 13 is movably provided in a space formed after the conveying unit 9 is moved to the retracted position.

Although the present disclosure has been described in particular embodiments, the present disclosure is not limited to the foregoing embodiments. A person skilled in the art may modify the above embodiments, so long as they do not deviate from the scope and object of the present disclosure.

1. An ink jet recording apparatus comprising:
an inkjet head provided with a nozzle surface on which ink ejection ports of a plurality of nozzles are opened downward;
a supply path through which a cleaning liquid is supplied;
a blade movable in contact with the nozzle surface; and
a cleaning liquid supply member which supplies the cleaning liquid supplied through the supply path to at least one of the nozzle surface and the blade, wherein
the cleaning liquid supply member has at least one supply hole through which the cleaning liquid is supplied, and the supply path has a supply part inserted into the supply hole.

2. The inkjet recording apparatus according to claim 1, wherein
an inner dimension of the supply hole is increased upward.

3. The inkjet recording apparatus according to claim 1, wherein
the supply hole has a portion whose inner dimension is smaller than an outer dimension of the supply part except for an upper end of the supply hole.

4. The inkjet recording apparatus according to claim 1, wherein
the supply hole has a small dimension portion at which a dimension is discontinuously small in the middle, and
an opening of the supply hole opened on a cleaning liquid supply surface of the cleaning liquid supply member has an inner dimension smaller than an outer dimension of the supply hole.

5. The inkjet recording apparatus according to claim 1, wherein
the supply part makes the cleaning liquid in contact with an inner wall of the supply hole.

6. The inkjet recording apparatus according to claim 1, wherein
the supply part is inserted into the supply hole until its tip end reaches a lower end of the supply hole.

7. The inkjet recording apparatus according to claim 1, further comprising:
a cleaning liquid supply mechanism which is disposed separated away from the inkjet head and supplies the cleaning liquid to the cleaning liquid supply member, wherein
the cleaning liquid supply member is supplied with the cleaning liquid from the cleaning liquid supply mechanism, is then separated away from the cleaning liquid supply mechanism and moved to a position where it can be in contact with the nozzle surface while holding the supplied cleaning liquid, and the supply part is inserted into the supply hole at the position.

8. The inkjet recording apparatus according to claim 5, further comprising:
a wipe unit including the blade and the cleaning liquid supply member, wherein
as the wipe unit moves, the blade and the cleaning liquid supply member are moved.

9. The inkjet recording apparatus according to claim 1, further comprising:
a wipe unit including the blade, the cleaning liquid supply member, and a waste liquid tray disposed below the blade and the cleaning liquid supply member to receive the cleaning liquid falling from the cleaning liquid supply member and the ink wiped by the blade, wherein
when the cleaning liquid supply member is moved, the waste liquid tray is kept at a position below the cleaning liquid supply member.

10. The inkjet recording apparatus according to claim 1, wherein
the supply part can be moved to a separated position where a tip end is separated from the supply hole, an insertion position located in the supply hole, and a penetration position protruding from the supply hole.
